(19) United States
(12) Patent Application Publication
(10) Pub. No.: US 2016/0009196 A1
(43) Pub. Date: Jan. 14, 2016

(54) Vehicle guidance, propulsion and switching via magnetic forces

(71) Applicant: Francois Allard, Ottawa (CA)

(72) Inventor: Francois Allard, Ottawa (CA)

(21) Appl. No.: 14/330,482

(22) Filed: Jul. 14, 2014

(51) Int. Cl. B60L 13/10

(52) U.S. Cl. CPC B60L 13/10

(57) ABSTRACT

A guideway vehicle system using Linear Motors where the vehicle bound translators act laterally against ferromagnetic stators on regular guideway sections and interact singly with magnet arrays on one side or the other in switch guideways sections.

A Linear Switched Reluctance Motor which enables the aforementioned behavior using dual-sided magnetic attraction and repulsion.

An embodiment of this invention specifically applicable to PRT (Personal Rapid Transit) where balance is provided to a monorail-type vehicle by Linear Motors.

A safety case for the above that assures the vehicle remains captive to the guideway which can also be used as a non-magnetic version applicable to PRT where balance is provided to a monorail-type vehicle.

### TECHNICAL FIELD OF THE INVENTION

The invention relates to vehicle guidance, propulsion and switching, notably via magnetic forces.

This invention can be used to provide lateral stability and balance for monorail type of applications. It can also be used for wheeled, air cushioned, magnetically levitated or other means which require propulsion, switching and guidance. It can be used in supported and suspended embodiments.

Further, it allows switching without mechanical movement of the guideway. This can be used to reduce headways in applications where close following is necessary. For example PRT (Personal Rapid Transit) systems and high-speed applications.

Another feature is the ability to impart longitudinal force from wayside means.

Electromagnets are used for propulsion and guidance. Wayside permanent magnets or electromagnets are used only in the switch area or wayside propulsion boost areas.

### BACKGROUND OF THE ART

Reducing the expense of guideway for PRT and more generally ATN (Automated Transit Networks) or general class of podcars is difficult to achieve. Guideway cost can account for more than 50% of an ATN system cost. Use of an I-beam over a box-beam or U-beam could reduce cost by reducing the amount of material needed for a given span since the I-beam minimizes top load bending. More importantly, I-beams are standard profiles that can be extruded by multiple vendors reducing production cost to essentially the cost of steel. I-beams have been shown to have a longer lifespan than steel box-beams.

Progress in this area includes the use of a shared box beam for top and bottom running podcars, as disclosed in U.S. Pat. No. 4,000,700.

There have been schemes to provide switching via magnetic means. U.S. Pat. No. 3,763,788 and U.S. Pat. No. 5,778,796 allows switching by selectively attracting one side or the other of a turnout but wheels are required to maintain the gap. This model also requires a U-shaped guideway for lateral guidance.

A combined magnetic suspension and propulsion system has been disclosed in U.S. Pat. No. 3,638,093 where all of the vehicle weight is supported by magnetic attraction requiring a significant amount of energy simply for this task negating some of the advantages of low friction, especially at low speeds like those found in a PRT setting where energy required to support the vehicle may exceed the energy needed to overcome rolling resistance.

### SUMMARY OF THE INVENTION

Disclosed is an invention that addresses guideway weight and complexity; small guidewheel maintenance, failure, speed limitation and expense; complex linkages; and switching time between one switch and the next for a guideway captive vehicle.

A steel I-beam, a rail roadbed or automobile roadbed with minimal framework, can form the infrastructure for this invention. The vehicle can ride on two wheels only, which are in a fore and aft configuration. It is an object of this invention to disclose means of balance for a vehicle running on two wheels, like a motorcycle, next to an I-beam or similar structure for support and balance.

Balance is maintained by forces against a guideway attached protrusion/stator that runs the length of the guideway at the top of the support structure. The stator is ferromagnetic and a pair of translators (electromagnet arrays) placed on either side of the stator vary their magnetic intensity to maintain balance. Selectively increasing one side's magnetic force and decreasing the other allows a shift in balancing load. Running one set of electromagnets closer and the other further from the stator can compensate for a unbalanced load without continuously putting more energy into one side or the other exceeding propulsion energy.

Since only balance needs to be maintained by electromagnetic forces, the energy needed to support and guide the vehicle is reduced compared to magnetically levitated vehicles, and steel wheels could provide very long service life. The lack of small wheels running along the side of the guideway means no maintenance to high rotation per traveled distance wheel-sets, no high bearing rotation speed limiting top speed, no sudden spin-up of non-contact wheels, less inventory and less maintenance downtime.

A steering mechanism on the steel wheels maintains them on a proper trajectory that also counters lateral forces the same way a turning vehicle counters lateral forces. So between the top electromagnets maintaining balance and bottom wheels maintaining trajectory, stability is attained. The guideway can be super-elevated or canted in curves, however, to maintain a smooth ride and reduce unnecessary lateral unbalanced forces.

The invention features a switch and a novel linear motor design in a particular embodiment. In one type of embodiment, translators, which are electromagnet arrays, are arranged in such a way that the supporting upright structural member of the vehicle is inline with one of the translators in such a way as to allow two sides of the translators to be used alternately on both the inside and outside. Inside magnetic is advantageous on regular sections, which are exclusive of switch area, such that a single attachment point is necessary for the back to back stator pair. When the electromagnet arrays operate exclusively in an outward fashion, two attachment points are needed for two stators. So for the former embodiment, a central running guideway mounted protrusion/stator pair bears lateral magnetic forces.

In a switch area however, the inside must be free of any protrusion to allow lateral movement. The outside face of the electromagnets now come into play. Only one side of the electromagnet pair will come into play and so it must interact with guideway permanent magnets, or electromagnets if more power must be imparted, to allow both repulsion and attraction which maintains the top of the vehicle laterally positioned. Wheels also follow the selected side to complete the turn.

A pair of electromagnets can, on regular spans, act on a central magnetic core material to maintain a central running gap range. Favoring one side or the other allows an unbalanced load to be carried at the expense of some energy, but much less than for a U.S. Pat. No. 3,638,093 type of vehicle which lifts its entire weight. At a merge or diverge point, the electromagnets can interact with a same polarity inward row of magnets, attracting or repulsing as needed to maintain the desired gap through the switch area. Propulsion would be by other means.

A mechanism using a LIM (Linear Induction Motor) which would act outwardly against a reaction rail in a U-shaped guideway, varying intensity of one side's propulsion electromagnet or the other keeps the vehicle centered. Wayside active coils in the switch area would act against the static LIM magnetic field essentially using a LSM (Linear Synchronous Motor) type of propulsion with a magnetic bias to maintain the desired gap. Such an arrangement requires an active guideway in switch areas.

A more efficient embodiment is to use a novel version of a LSRM (Linear Switched Reluctance Motor). This motor acts on alternating magnetic core material, herein referred to as cogs or steps, and airspace or other non-ferromagnetic material making a variable reluctance motor stator. The magnetic core material completes the magnetic circuit initiated by the E-shaped electromagnet. These are essentially laminated transformer coils and windings which makes manufacture very cost effective. A set of three or more per side is used for directional, that is forward or back, control. Electromagnets across from each other are activated with the same polarity orientation to minimize loss. The Electromagnets act against the switch area magnet arrays of same polarity but with spaces same as the main stator cogs. This essentially becomes an inverted activation LSRM mode with the added difficulty of maintaining a given separation gap or steady state within a gap range by varying the relative intensity of magnetic fields generated by the electromagnets. All polarities of the wayside permanent magnet array are matched and directed inward. The operation sequence is front to back in non-switch sections and all opposed except the off or reverse polarity active coil pair same as the regular section sequence. Wayside assist is provided by matching the on-board motor's activation sequence such that the same cog the on-board electromagnet is attracted to gets energized with the opposite polarity.

The further embodiment uses U-shaped laminations with dual coils acting longitudinally against longitudinally oriented stator laminations providing both cogs and a magnetic flux path from one cog to the next. Three or more coils act in sequence to move the motor along the stator. In a switch area, the coils change polarity such that both are acting with the same polarity at any given time so that the whole back of the U-shaped laminations act against wayside magnets. Wayside magnets are arranged in a spaced out but same polarity manner so that the bulk of the electromagnets act as gap-keepers and one at a time acts as a propulsion means.

There may be instances where the vehicle support structure requires spread apart members. This can be accommodated by splitting the central protrusion into two protrusions with the switch area logistically unchanged. Such lateral guidance, switch and propulsion ability may be desirable where maglev or air bearings, such as suggested in the popular Hyperloop proposal, are used to provide a wider stance. In the case where guideway powered propulsion is indicated, guideway electromagnets can act against the vehicle electromagnet coils which can be activated in an alternating configuration to allow electromagnets on the guideway side to operate without the need for a permanent magnet array or reaction plate onboard. The reaction plate or LSRM protrusion can be omitted in the guideway propelling area to avoid inducing magnetic drag.

A suspended embodiment is also possible. In this case, a double set of wheels is needed where one set is only active in the switch area. Since the vehicle runs on a single side normally and switches to the other side only on a diverge or inside merge, the alternate set is infrequently used. Using a suspended and supported embodiment allows a top-running version on one side and a bottom running version on the other of the supporting structure such as an I-beam. A space for cross-bracing and support at pillars can be created by having the top running bogie shorter than the suspended one and set inside so that support of the main I-beam, or equivalent, can be accommodated. This arrangement enjoys similar benefits of U.S. Pat. No. 4,000,700.

Since the bogie of the vehicle travels only on one side of an I-beam guideway, the support structure will tend to twist to the side with the load. To counter this, two lanes of the guideway can be connected, possibly periodically, with the other guideway forming essentially a box beam from two I-beams and some structural cross-bracing. This cross-bracing can alternate top and bottom where the top brace has a U-shape and the lower brace is straight. The braces may be connected with hinges.

The braces form a parallelogram such that up and down motion is transferred only as slight side to side motion on the connected guideway. These braces can be used to support the mesh walkway sometimes required for elevated systems. Alternately, especially for the top and bottom running application, a small I-beam or structural member can connect the guideway-forming longitudinally running I-beams, creating a U shape. These connecting members can be spaced as above and can support a walkway.

For heavy vehicles, a guideway trench below the road is used to transfer energy, hold the stator laminations, and provide a running surface for bogie wheels which would maintain bogie height. A fifth-wheel hitch carrier, which can be a modified dolly trailer used for road trains, above the road surface is attached by a coupler to the bogie through a slot in the road. The bogie guides and propels the carrier with possible assistance from carrier motors. Power can be transferred from the guideway bogie to the carrier. This narrow slot allows other traffic to use the road if needed. The hitch part above the road can have multiple sensors based on expected conditions, whether mixed traffic, exclusive roadway, or other conditions common to guided transport. Regular trailers can be used as carriers for all sorts of goods. Since the front of the trailer is captive, a narrow roadway with either wire or solid barriers is all that is needed. Benefits are increased traction due to LM in any weather, LM braking, electric propulsion and hotel services, being captive to guideway, full automation including switching and guidance. A completely enclosed, no fin or slot, cargo version for small objects is also possible with the load between sets of translators acting on outer edges.

Safety guides are structures that prevent the bogie from escaping the guideway if normal operation fails. On regular spans, this is done with a U-shaped trough the wheels run in. In the switch areas, this trough is replaced by the alternate side wall and a full bottom running surface until the desired path is sufficiently engaged such that the trough can once again ensure safety. On the top side, the protrusion is straddled in regular spans. In the switch area, two spans enclose the bogie, but a further pair of guideway safety guide acts against a vehicle bound safety guide pair. This pair of guides is engaged on one side or the other before entering the switch area. Alternately, in lower speed situations, a soft collision arrester like sand filled barrels can be used if quick succession merge and diverge areas are required. Active methods are possible for critical safety scenarios, perhaps at very high speeds, for example a style of rail selection as taught in U.S. Pat. No. 4,000,700 can be used in extreme cases as a safeguard, skid plates can be used in lieu of wheels as this is a failure mode.

Following the safety case, a mechanism allowing non-magnetic lateral stability, balance, switching and propulsion is disclosed. Traction and propulsion can be via main support wheels acting against a monorail. A novel way to increase traction in certain areas is to use a higher traction wheel such as polyurethane as the switch wheel, instead of low rolling resistance and fraction steel for example, such that in acceleration or hill sections a switch to the turn side engages the higher traction wheel. Alternately, a traction wheel adjacent the main wheel is engaged by a track profile change where needed. Small guide wheels acting against guideway sections are used in this case instead of skid plates in a way similar to what is taught in U.S. Pat. No. 4,000,700 or EP 0116021. A mix of wheeled and magnetic embodiments can run on the same guideway. The various embodiments of the invention are described in detail with reference to the following figures.

### BRIEF DESCRIPTION OF THE FIGURES

FIG. 1 is a cutaway view of the guideway and bogie with forward direction into the page.

FIG. 2 is an isometric view of the bogie.

FIG. 3 is the bogie of the present invention in the switch transition area.

FIG. 4 is the bogie in the switch commit area with the left side engaged.

FIG. 5 is the bogie in the switch commit area but with a right turn selected.

FIG. 6 is the bogie in the switch follow area with the safety catch engaged.

FIG. 7 is the bogie in the switch follow area with the safety catch engaged but with a right turn selected.

FIG. 8 is the bogie in a wayside boost section.

FIG. 9 is the preferred embodiment of the linear motor in regular section.

FIG. 10 is an isometric view of FIG. 9.

FIG. 11 is an embodiment of the linear motor in a high speed section or switch area. Only the top laminations or bottom magnets would be present at one time.

FIG. 12 is an isometric view of FIG. 11.

FIG. 13 is a simpler embodiment of a linear motor. Only the top laminations or bottom magnets would be present at one time.

FIG. 14 is an isometric view of 13.

FIG. 15 is the suspended version of the invention.

FIG. 16 is the cargo version of the invention.

FIG. 17 is the wide/maglev version of the invention.

FIG. 18 is the safety mechanism in regular guideway sections.

FIG. 19 is the safety mechanism in a transition guideway sections of a switch.

FIG. 20 is the safety mechanism in a selected guideway sections of a switch.

FIG. 21 is a side view of the safety mechanism in a left turn position.

FIG. 22 is a side view of the safety mechanism in a right turn position.

### DETAILED DESCRIPTION OF THE INVENTION

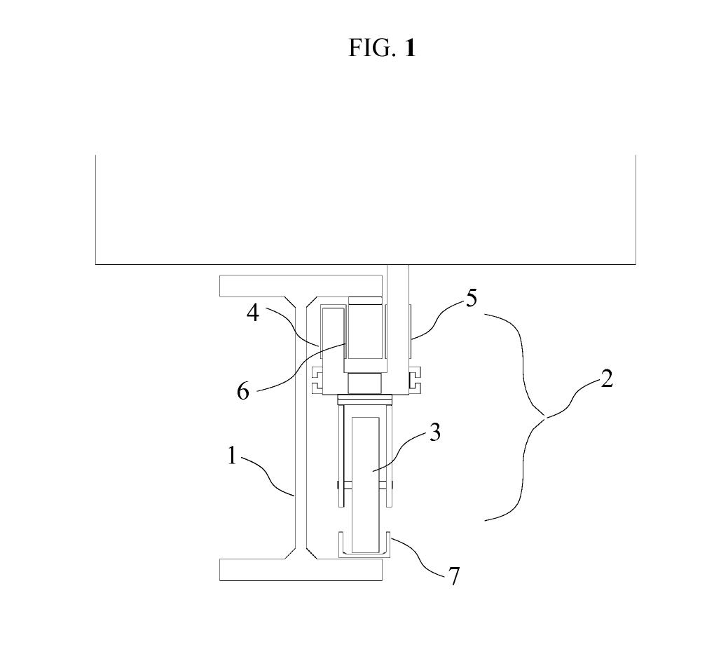

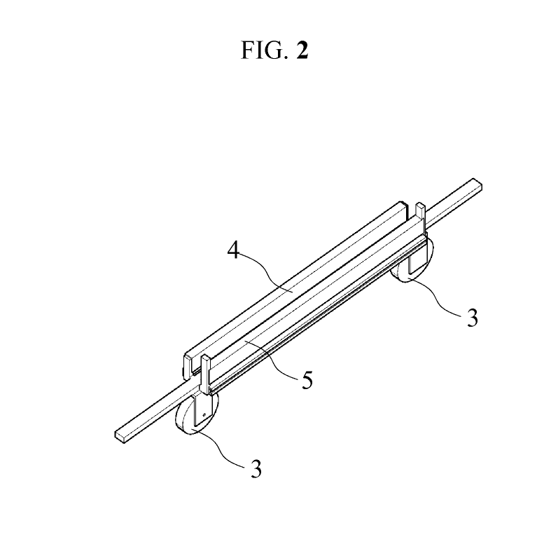

Referring to the drawings, in FIG. 1, the main embodiment uses an I-beam 1 as a support structure. The bogie 2 runs along one side of it. The bogie is guided by both the electrically steered wheels 3 and by adjusting the intensity of facing translators 4, 5. The stator 6 keeps the top of the bogie constrained while a U-channel rail 7 constrains the bottom from escaping the guideway.

Translators are electromagnets arrays of various configurations and stand as a placeholder for part of a Linear Motor (LM), not counting the stator, used in this invention.

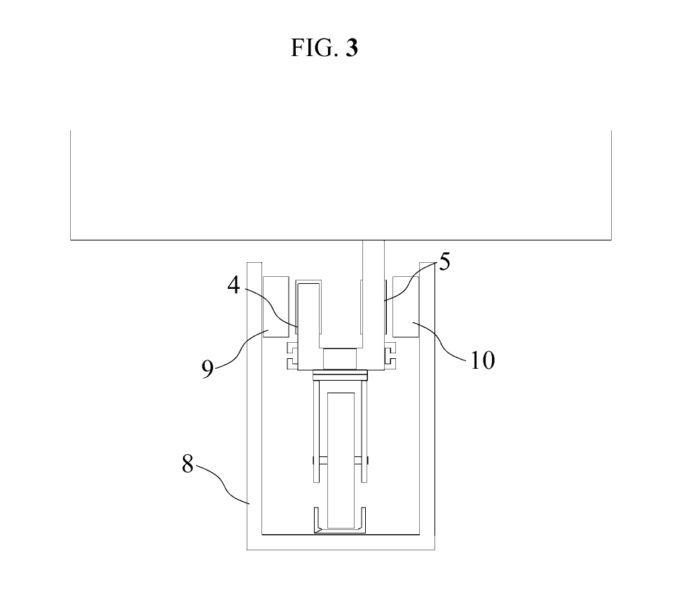

In a switch section, FIG. 3, the support structure changes to a U-shape 8. This allows the bogie to move to one side or the other without being encumbered by centre mounted protrusions and stator. Guidance is now provided by the outward side of the translators 4, 5 and they no longer act in a pair, but one of the translators 4 or 5 acts on the side the bogie it is to follow. This is done with an array of wayside permanent magnets 9 and 10 all with the same pole inward. So translator 4 interacts with wayside permanent magnets 9 when going left and translator 5 interacts with magnetic stator 10 when going right. This first part of the switch is a transition area. In this section, the guideway has widened for some distance and path selection by magnetic forces has been made.

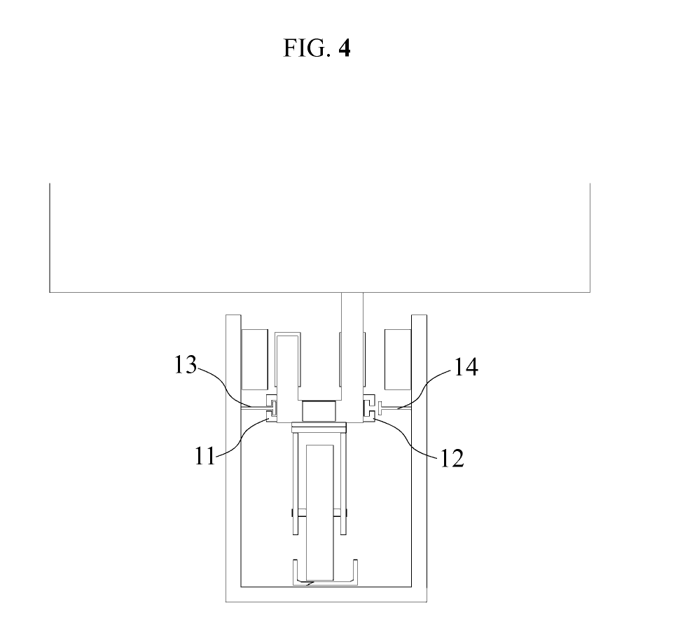

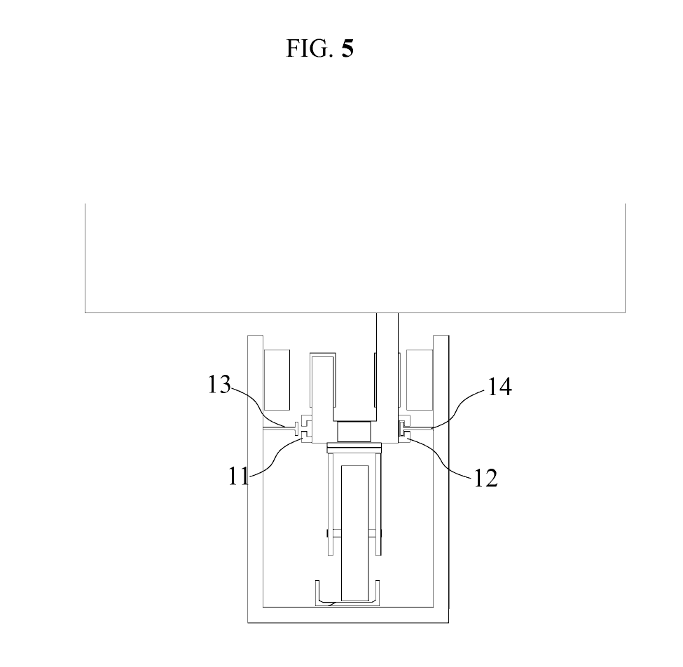

The safety catch 11, 12 engages its guideway bound counterpart 13,14 as shown in FIG. 4 for a left turn and in FIG. 5 where the left side was chosen and the left catch is engaged a little further in the turn. The safety catch prevents the bogie from escaping the guideway in the switch area which can be open. The safety catch can also be engaged before the split occurs allowing brakes to be applied on failure for guaranteed success if the safety catch is properly engaged at that point. The safety catch can be omitted in certain circumstances, low speed for example, relying instead on a soft barrier at the point as a precaution in case of unlikely failure as is done at highway off-ramps.

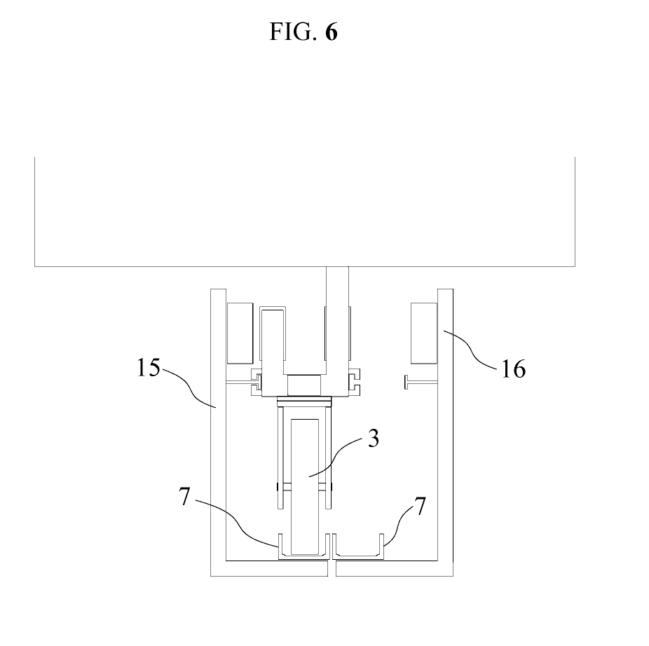

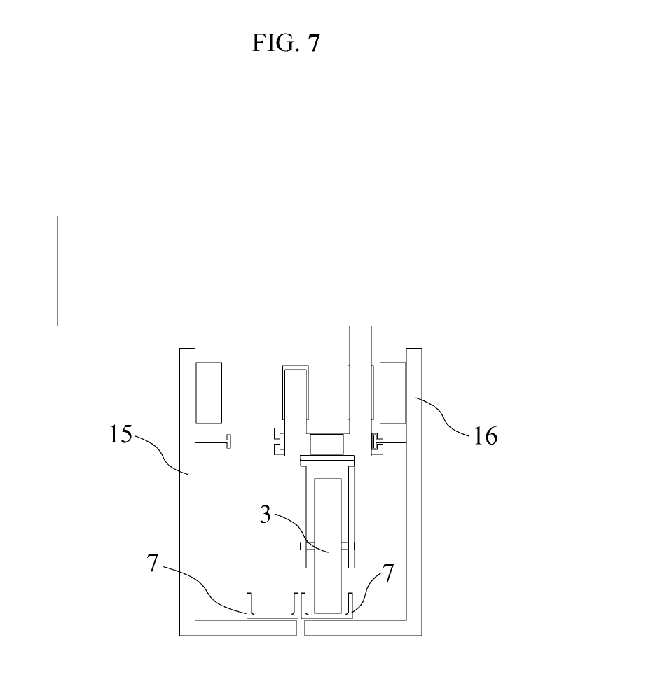

FIG. 6 describes the left side selection further down the switch. Note that the U-channel rail 7 once again constrains the wheels 3 of the bogie. The support structure 15 and 16 is now an L-shape optionally with a box beam as support or a wide U-shape support structure formed from the L-shapes of either side. FIG. 7 illustrates an embodiment with the right side engaged. Once the distance between the two guideways is large enough, both sides return to a type of guideway structure as described in FIG. 1 constrained without the catches as described earlier.

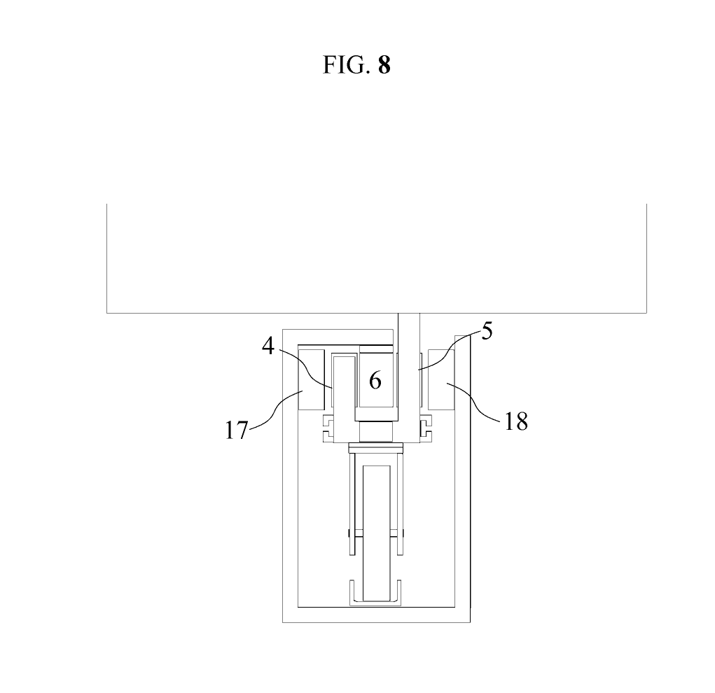

Wayside propulsion, FIG. 8, is accomplished by imparting extra force to the on-board translators 4, 5 using a wayside array of electromagnets or permanent magnet enhanced electromagnets 17, 18. For certain embodiments, the central stator can be removed resulting in a U-shape guideway 8 configuration as demonstrated in FIG. 3, if it interfered with the linear motor selection which means wayside interactions are solely responsible for guidance as well as propulsion.

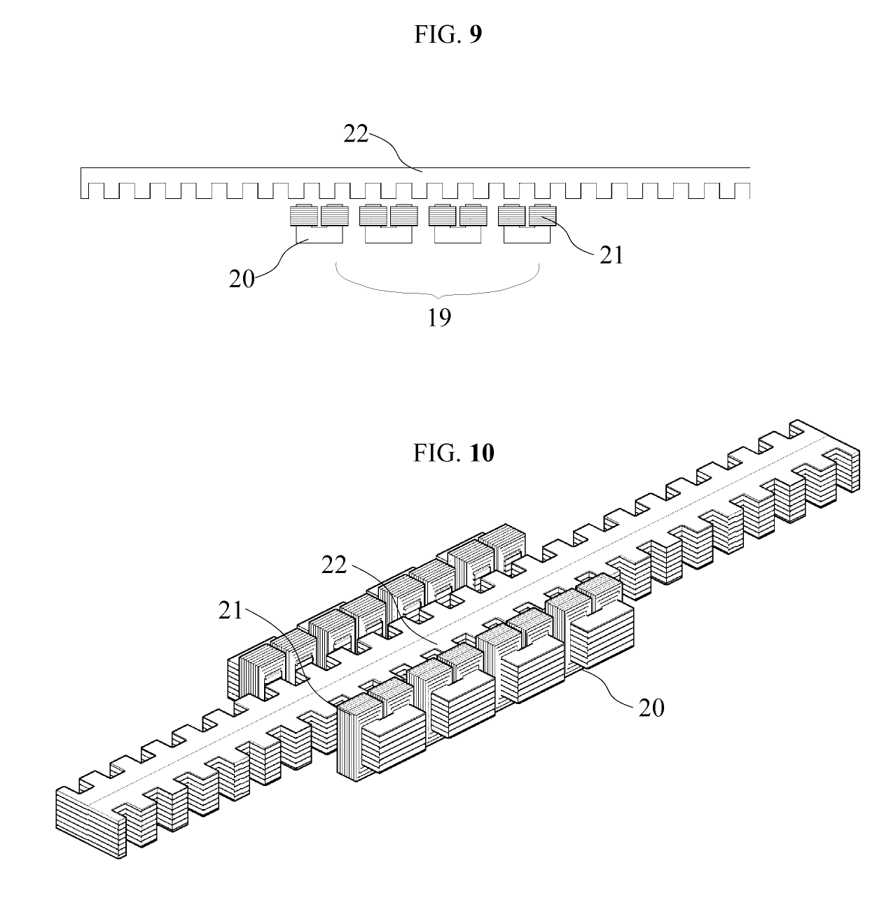

A preferred linear motor embodiment, FIG. 9, is a translator 19 made of a plurality of laminations forming U-shaped electromagnets 20 with coils at each end 21. These electromagnets act against the inward protrusion of stators 22 made from laminations with cogs that extend out in a step pattern of non-ferromagnetic, for example air, and ferromagnetic material forming the variable reluctance for the linear motor.

Spacing of the stator 22 cogs relative the electromagnets 20 for a four pole translator is arranged as shown. The firing sequence is a simple progression from front to back (right to left for a rightward movement of the translator on the page) which completes a cycle, advancing the translator 19 to the next cog of the stator 22. Firing of each electromagnet coil is via computer controlled drivers. A computer controller also steers the bogie wheels 3 to coordinate basic vehicle operation.

Depending on available space and top speed desired, multiple translator assemblies can be mounted to the bogie which means that multiple gap-keeping points can exist. The gap is measured by electromagnetic and/or optical means via hall effect sensors or photoelectric sensors respectively. These are needed on both the inward and outward sides of the electromagnets, not shown.

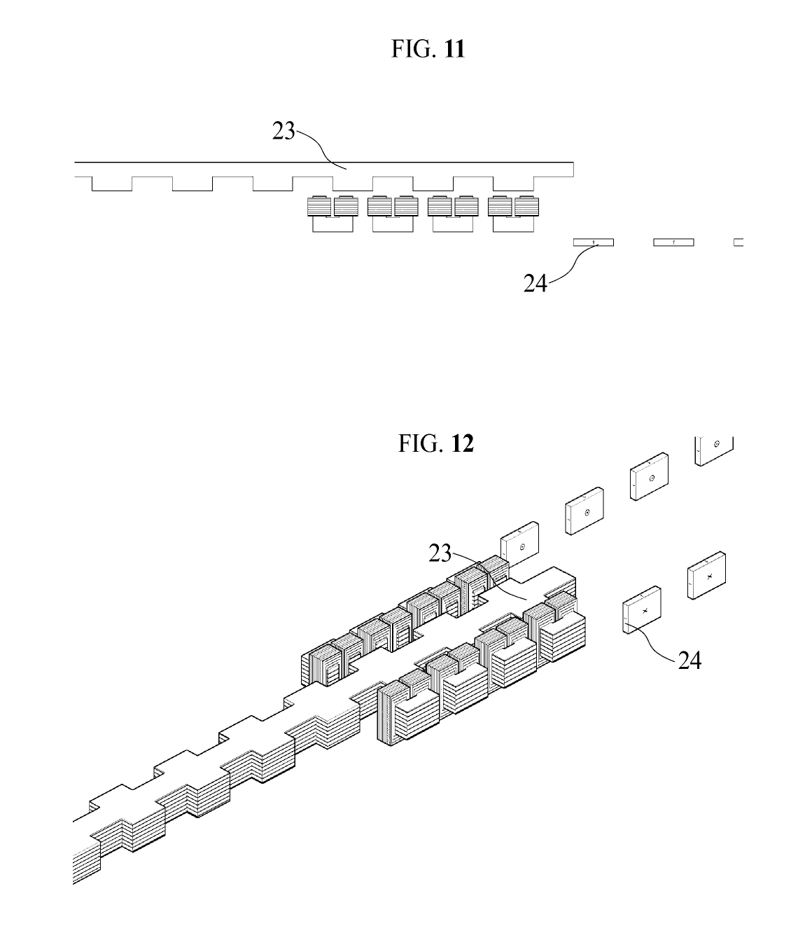

The switch section is configured to take advantage of this motor. Its back side is three times longer than the front side so that in one cycle, three times more distance is travelled. This means that the switch area stator is less granular. See FIG. 10. The activation sequence changes from front to back to back to front to advance the translator. The placement of the translator electromagnets to satisfy two types of stators, one for the principal guideway and another for the switch guideway area, means that changing the activation sequence is necessary satisfy both types without mechanically changing their spacing. See FIG. 11. Three of the four electromagnets can vary their intensity to maintain the necessary gap, either being repulsive by virtue of matching polarity or attractive by virtue of ferromagnetic attraction or opposite polarities with respect to the switch magnet arrays 24. The last electromagnet which acts as the propulsion electromagnet attracts the desired side's switch magnet array 24.

Of particular significance and benefit is that the three-fold increase in cog size in the switch area translates to a three-fold speed gain for a similar cycle period. This means that by modifying certain sections of track stators 23, in particular high-speed sections, the vehicle can triple its top speed. FIGS. 11 and 12 illustrate both the switch magnet array 24 and the high-speed stator sections 23.

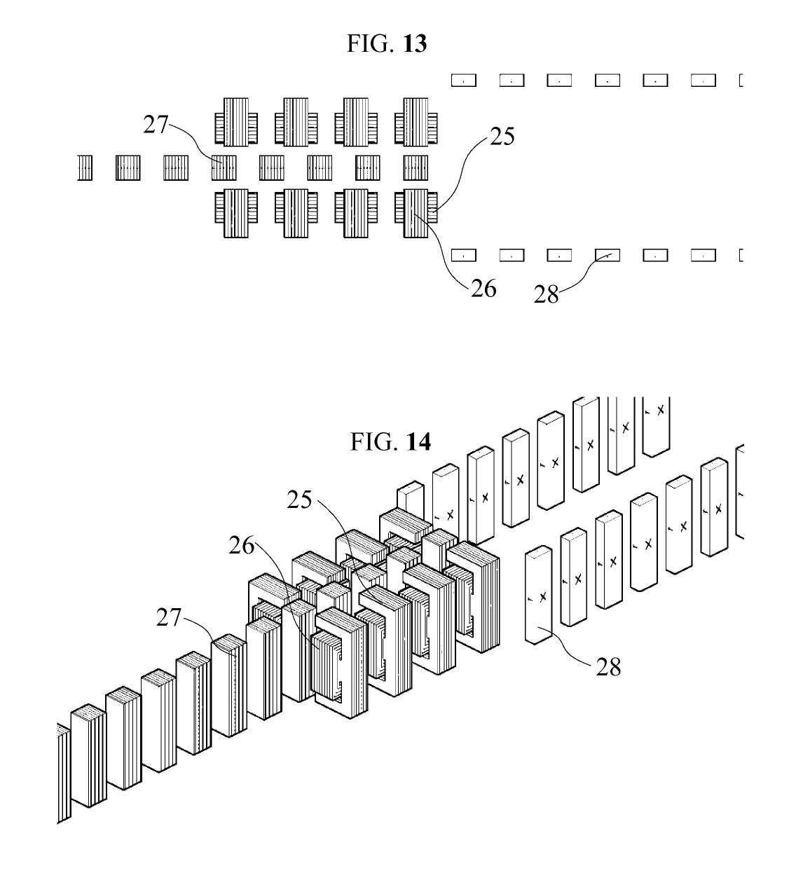

A simpler linear motor embodiment, FIG. 13, uses E-shaped translator electromagnets 25 with a single coil 26 on the middle segment, transversely mounted so that magnetic flux is completed by transversely mounted cog laminations 27. The arrangement has a similar sequence to the preferred embodiment, front to back. In the switch section, permanent magnets 28 interact in a similar way to the preferred embodiment described previously.

The suspended variation, FIG. 14, has two pairs of wheels 29 but only one side of each pair is engaged in main line operation. In a switch section, both wheels are engaged and a decision is made in a similar way to the preferred embodiment.

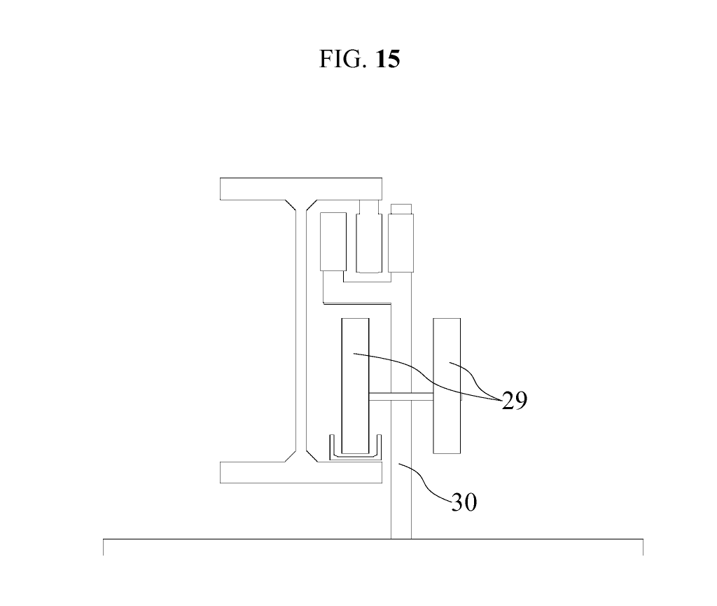

A cargo version, FIG. 15, either carries its cargo in a small space (like a tube or trough) with the motors at either end acting outward with the stator 31, or with a fin 32 that connects to a load-carrying vehicle above providing propulsion, guidance and switching for the carrier.

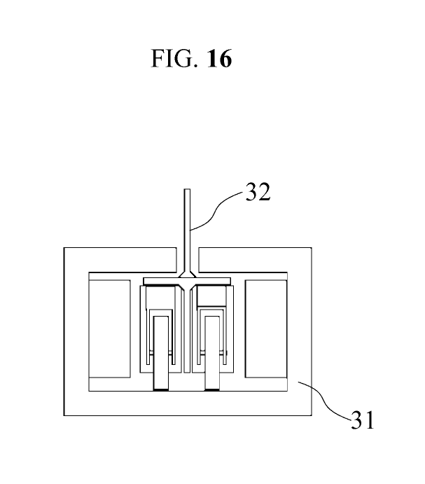

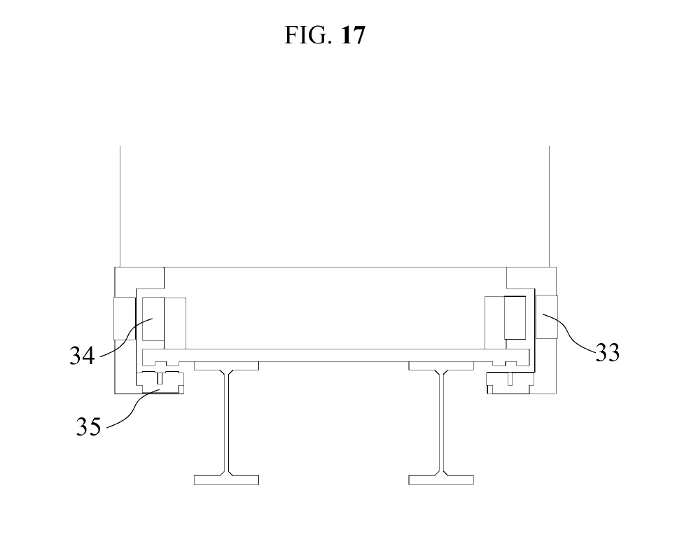

The wide/maglev variation, FIG. 16, works as others do but guidance is to lateral position, especially in an air cushion or maglev lift situation. The stator rails 34 are still inward on main lines but separated to allow the vehicle support structure through. Switching is the same as the main embodiment using vehicle mounted electromagnet arrays 33. In a maglev version, the U-shaped support electromagnets 35 have winding similar to the linear motor preferred embodiment with coils at each end. These coils can be polarity aligned in the switch area to act against a bed of opposing polarity permanent magnets. This allows the vehicle to float repulsively through the switch and using attraction in regular sections. The U-shaped support electromagnets 35 can also have a permanent magnet core coil one side of the U-shape so that the repulsive and attractive effects occur without energy to a certain degree. A similar method would use a bed of coil loops as in Inductrack™ to provide inductive counter-polarity lift to a longitudinally alternating polarity set of electromagnets. The U-shaped support electromagnets 35 can also have a permanent magnet core coil on alternating sides of the U-shape so that the repulsive and attractive effects occur without energy to a certain degree.

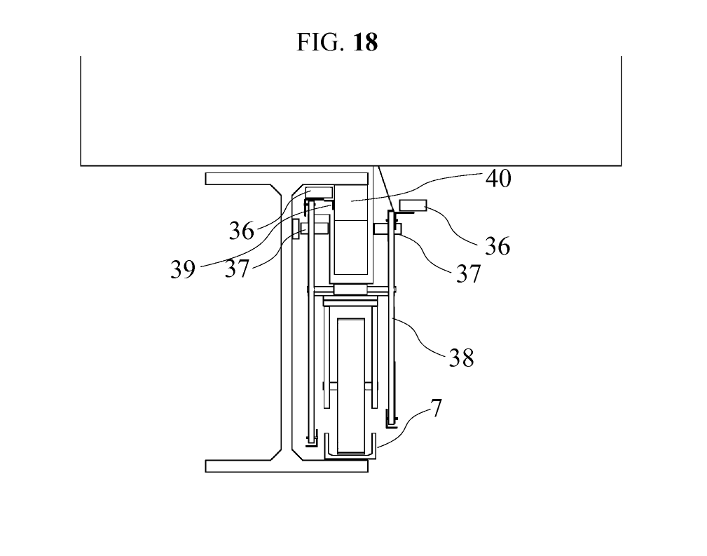

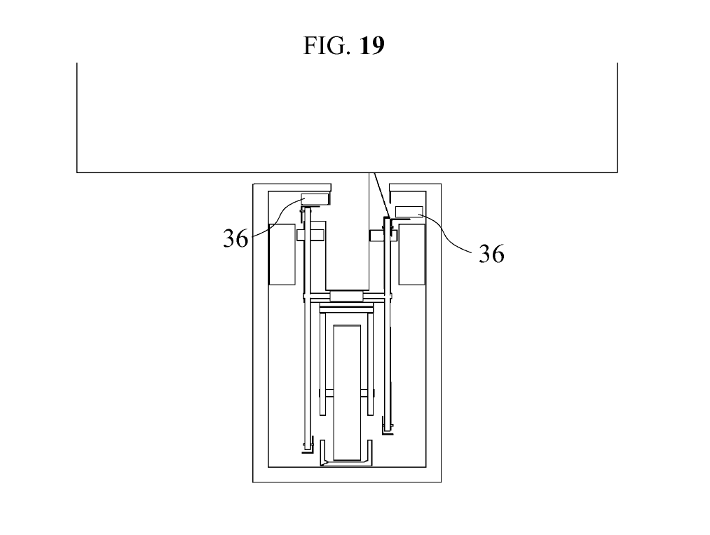

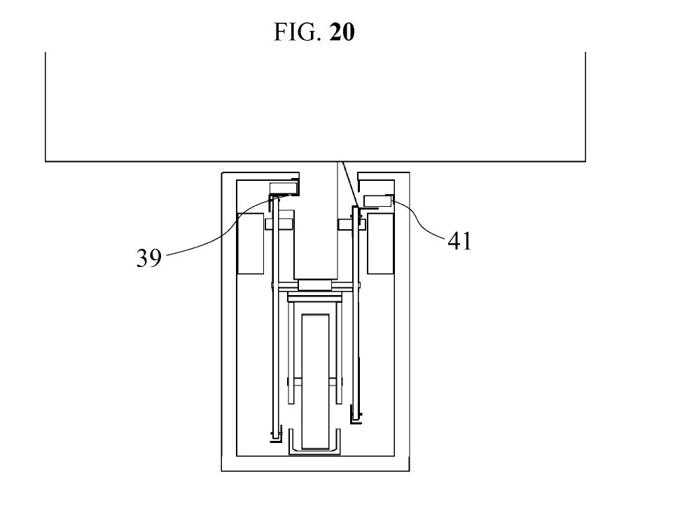

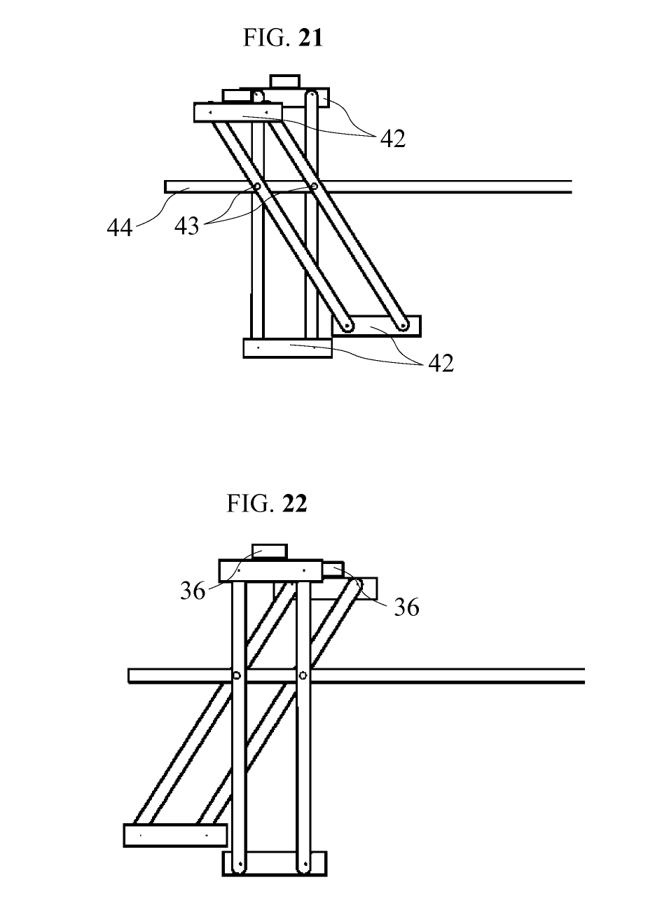

A mechanism to provide either a safety case or a non-magnetic embodiment is shown in FIGS. 18 to 22. Depicted wheels 36 and 37 can be replaced by skid plates if the mechanism is only used as a safety for the magnetic case. A twisted H-shaped arm 38 is attached to the bogie frame 44 by a set of bearings on spindle 43 attached to the upright arms forming the twisted H-shape and allowing rotation of the arms from front to back. Bearings also attach the horizontal plates 42 and guidewheels 36 are attached to plates via bearings as well, see FIG. 21. When on regular guideway, FIG. 18, the left side turn selection wheel 36 is locked into it's channel by locking ridge 39 which is attached to the stator mount 40. This also locks the bottom of the twisted H-shaped arm 38 in a vertical position preventing escape from the guideway should traction on the main wheels become inadequate or the steering mechanism fails. The U-channel rail 7 also serves this purpose outside the switch area which means that a standard rail profile can be used instead, but solely relying on the selection mechanism H-shaped arm in regular sections. The turn selection wheel 36 doubles as guidance wheel with the other outside acting wheel 37. In the transition section, FIG. 19, the twisted H-shaped arm is free to rotate such that the right turn selection or the left turn selection wheel 36 is engaged. As noted earlier, the vertical position of the twisted H-shaped arm on either the left or right side guarantees maintenance of the correct path. FIG. 20 shows the locking ridges 39 and 41 used to lock the selection made in the transition section through the turn. FIGS. 21 and 22 show a side view of the selection mechanism engaged in a left and right turn respectively.

What is claimed is:

1: A vehicle system for the propulsion and/or guidance of a vehicle, the system comprising:
at least one vehicle mounted bogie, said bogie comprising a pair of electromagnetic translators, said translators each comprising a respective array of electromagnets,
said system including at least one of a principal guideway and can have one or many switch guideway,
where the principal guideway comprises at least one principal guideway stator, wherein said at least one principal guideway stator is positioned to be adjacent at least one of said translators;
said switch providing a choice of paths between separate available routes,
where the switch guideway comprises two switch stators, said switch stators comprising magnetic field generating elements, a respective switch stator located adjacent an outward side of a respective one of the two translators;
wherein in the principal guideway, the translator generates an electromagnetic field along the array of electromagnets which moves along the translator and interacts with the principal guideway stator to generate a force acting between the stator and the translator in a desired direction of travel, and
wherein in the switch guideway, the translator generates an electromagnetic field that generates a lateral force relative to the travel direction of the bogie which guides the bogie towards a desired one of said available switch routes.

2: The system of claim 1, comprising at least one principal guideway and at least one switch guideway.

3: The system of claim 1 or 2, wherein said translators provides both propulsion and guidance in a principal guideway or switch guideway.

4: The system of any of claims 1-3, where at least one translator acting on a principal guideway stator and/or switch guideway stator provides guidance.

5: The system of any of claims 1-4, where the principal guideway stator comprises at least two said stators positioned outwardly adjacent the translators or inwardly between the translators.

6: The system of any of claims 1-5, where at least one principal stator or switch stator comprises alternating sections of high ferromagnetic material and low-ferromagnetic, or non-ferromagnetic, material.

7: The system of any of claims 1-6, where the translators interact with outwardly positioned stators in switch guideway sections and interact with inwardly positioned stators in other guideway types.

8: The system of any of claims 1-6, where the translators interact with outwardly positioned stators on all guideway types.

9: The system of any of claims 1-8, where principal guideway electromagnets or switch guideway electromagnets acting as wayside translators propel or assist in propelling the vehicle by magnetically acting against the vehicle bound translators acting as stators or translators.

10: The system of any of claims 1-9, where guideway electromagnets propel or assist in propelling the vehicle by magnetically acting against the vehicle bound translators.

11: The system of any of claims 1-10, where the vehicle is a maglev vehicle system comprising an arrangement where upward acting electromagnets, or electromagnet enhanced permanent magnets, attract a ferromagnetic guideway in all but switch areas where said electromagnets repel a set of opposed polarity permanent magnets arranged so as to support said vehicle countering gravity forces.

12: The system of any of claims 1-10, where the vehicle is a maglev vehicle system comprising an arrangement where upward acting electromagnets magnets, or electromagnet enhanced permanent magnets, attract a ferromagnetic guideway in all but switch areas where the said electromagnets hold an alternate polarity to induce an opposing magnetic field in guideway mounted coil loops.

13: A maglev vehicle system comprising an arrangement where upward acting electromagnets, or electromagnet enhanced permanent magnets, attract a ferromagnetic guideway in all but switch areas where the said electromagnets repel said vehicle countering gravity forces.

14: The system of claims 13, where the said electromagnets repel a set of opposed polarity permanent magnets arranged so as to repel said vehicle countering gravity forces.

15: The system of claims 13, where the said electromagnets hold an alternate polarity to induce a an opposed polarity magnetic field in guideway mounted coil loops.

16: A Linear Motor comprising a translator comprising coils mounted to form an array; and a pair of stepped-profile stators positions; the translator can magnetically interact at one time with a stator positioned on one side or at another with a stator positioned on the other side by changing magnetic fields in the translator to match the stator position.

17: The Linear Motor of claims 16, where said translator coils are E-shaped cores transversely mounted to form an array.

18: The Linear Motor of claim 17 where said translator coils can interact with stators on both of its sides at the same time.

19: The Linear Motor of claims 16, where said translator coils are U-shaped cores longitudinally mounted with coils at either end of said cores arranged to form an array; said translator can operate with two periods such that given one stator stepped-profile period, one speed is attained and, given another stator with stepped-profile period three times longer, a higher speed is attained using the same translator with a different magnetic activation sequence.

20: A vehicle system for the balance, guidance and switching of a monorail vehicle, the system comprising: at least one vehicle mounted bogie, said bogie comprising at least four guide-wheels and a selection mechanism connected to the two side's outward-pushing guidewheels; said bogie also comprising one or more support wheels; a regular guideway with facing guiderails; one or many U-shaped switch guideway with facing guiderails on both sides; one bogie side's said guidewheel pushing outwardly against the guiderail, one pushing inwardly against a guiderail; a similar set of guidewheels active only in a switch section, against a similarly configured guideway; a selection mechanism allowing one side's outward-pushing guidewheel to engage one side or the other's said outward-facing switch guiderail to choose the desired path.

21: The system of claim 20 where said guidewheels are replaced with skid-plates to serve as an active safety mechanism where regular operation is provided by other means.
